(19) United States
(12) Patent Application Publication
(10) Pub. No.: US 2014/0332652 A1
(43) Pub. Date: Nov. 13, 2014

(54) GAS STRUT SUPPORT

(71) Applicant: John E. Hansen, Brush, CO (US)

(72) Inventor: John E. Hansen, Brush, CO (US)

(21) Appl. No.: 14/275,679

(22) Filed: May 12, 2014

Related U.S. Application Data
(60) Provisional application No. 61/822,398, filed on May 12, 2013.

(51) Int. Cl. F16F 9/56

(52) U.S. Cl. CPC F16F 9/56
USPC 248/351

(57) ABSTRACT

A gas strut support can include a first end and a second end opposite the first end. The first end of the gas strut support can be configured to attach to a first portion of a gas strut, and the second end of the gas strut support can be configured to attach to a second portion of the gas strut. The gas strut support can prevent a piston rod of the gas strut from retracting into a cylinder of the gas strut when a compressive force is applied between the piston rod and the cylinder of the gas strut. The gas strut support has a wide array of applications including, but not limited to, automotive, domestic, and industrial applications.

### CROSS-REFERENCE TO RELATED APPLICATION

This application claims the benefit of U.S. Provisional Patent Application No. 61/822,398, filed May 12, 2013, which is hereby incorporated by reference in its entirety.

### FIELD

The present application relates to support members for gas struts.

### BACKGROUND

Gas struts, also known as lift supports, liftgate struts, pneumatic struts, gas strut lifts, and gas spring struts, are commonly used to provide lift support and damping in automotive, domestic, and industrial applications. In automotive applications, lift supports are commonly used for hoods, engine compartments, doors, hatches, tonneau covers, liftgates, and tailgates. In domestic applications, lift supports are commonly used for chairs, doors, sunbeds, and pull-down attic staircases. In industrial applications, lift supports are commonly used for doors, hatches, and machine guards. These applications are provided only as examples; many other applications exist.

A gas strut often has a chamber containing an inert gas at a high pressure, which provides a spring force that allows the gas strut to lift and hold open a structure, such as a door or hatch to which the gas strut is attached. The gas strut can contain oil, such as mineral oil, to provide damping during opening and closing of the structure. Damping prevents the structure from opening and closing too quickly, thereby enhancing safety and ease of use. The gas strut can also include a seal, such as a multiple-lip seal, configured to ride on a piston rod, such as a chromed piston rod that extends from and retracts into the gas strut. The seal can prevent oil or pressurized gas from escaping from the gas strut during operation.

Over time, performance of the gas strut can degrade. For instance, surface imperfections can develop on the piston rod and the seal can experience wear, potentially resulting in leakage of oil or gas from the gas strut. As oil or gas escapes from the gas strut over time, its performance will degrade, and it will eventually be unable to hold open a structure as intended. At this point, the gas strut is commonly replaced.

### BRIEF DESCRIPTION OF THE DRAWINGS

FIG. 1 is front perspective view of a gas strut support;

FIG. 2 is a rear perspective view of the gas strut support of FIG. 1;

FIG. 3 is a left side view of the gas strut support of FIG. 1;

FIG. 4 is a right side view of the gas strut support of FIG. 1;

FIG. 5 is a rear view of the gas strut support of FIG. 1;

FIG. 6 is a front view of the gas strut support of FIG. 1;

FIG. 7 is a top view of the gas strut support of FIG. 1;

FIG. 8 is a bottom view of the gas strut support of FIG. 1;

FIG. 9 shows a gas strut installed on a vehicle and the gas strut support of FIG. 1 engaged with the gas strut; and

FIG. 10. shows a gas strut installed on a vehicle and the gas strut support of FIG. 1 disengaged from the gas strut.

### DETAILED DESCRIPTION

A gas strut can include a cylinder 915 having a first end and a second end opposite the first end. The second end of the cylinder 915 can include a sealed opening from which a piston rod 910 extends. The piston rod 910 can include a first end that is slidably captured within the cylinder 915 and a second end opposite the first end. When no compressive force is applied to the gas strut 905, gas pressure within the cylinder 915 can act against a piston connected to the first end of the piston rod 910 resulting in the piston rod fully extending from the cylinder.

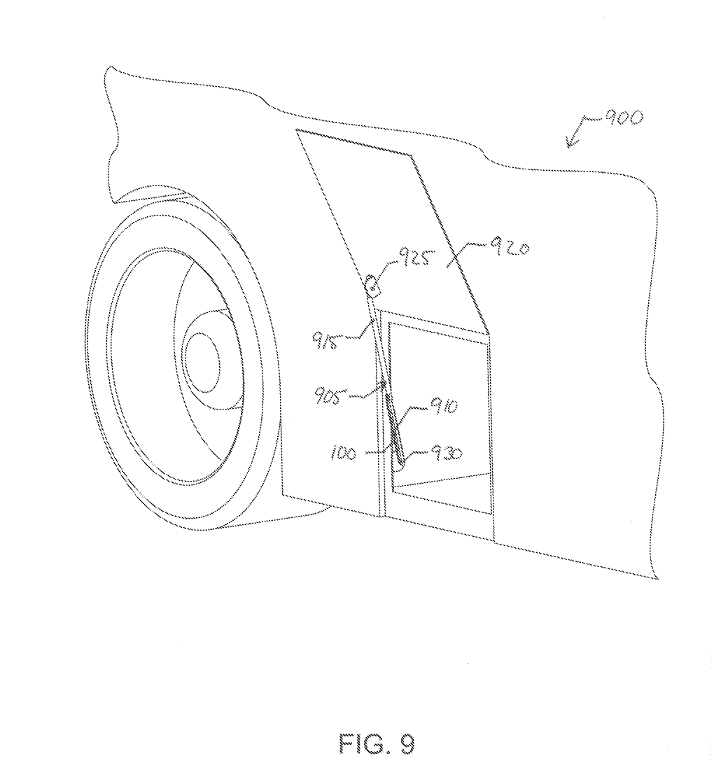

The gas strut 905 can include a first end fitting at the first end of the cylinder 915 and a second end fitting at the second end of the piston rod 910. The first and second end fittings can allow the gas strut to be mounted to a first and second mounting point, respectively. The first and second end fitting can be any suitable type of end fittings such as, for example, brackets, angle joints with ball pivots, angle joints without ball pivots, metal eyes, fork heads with pins, or ball joints. As shown in FIG. 9, the first end fitting of the gas strut 905 can be attached to a first mounting point 925 on a vehicle 900, and the second end fitting of the gas strut can be attached to a second mounting point 930 on the vehicle 900.

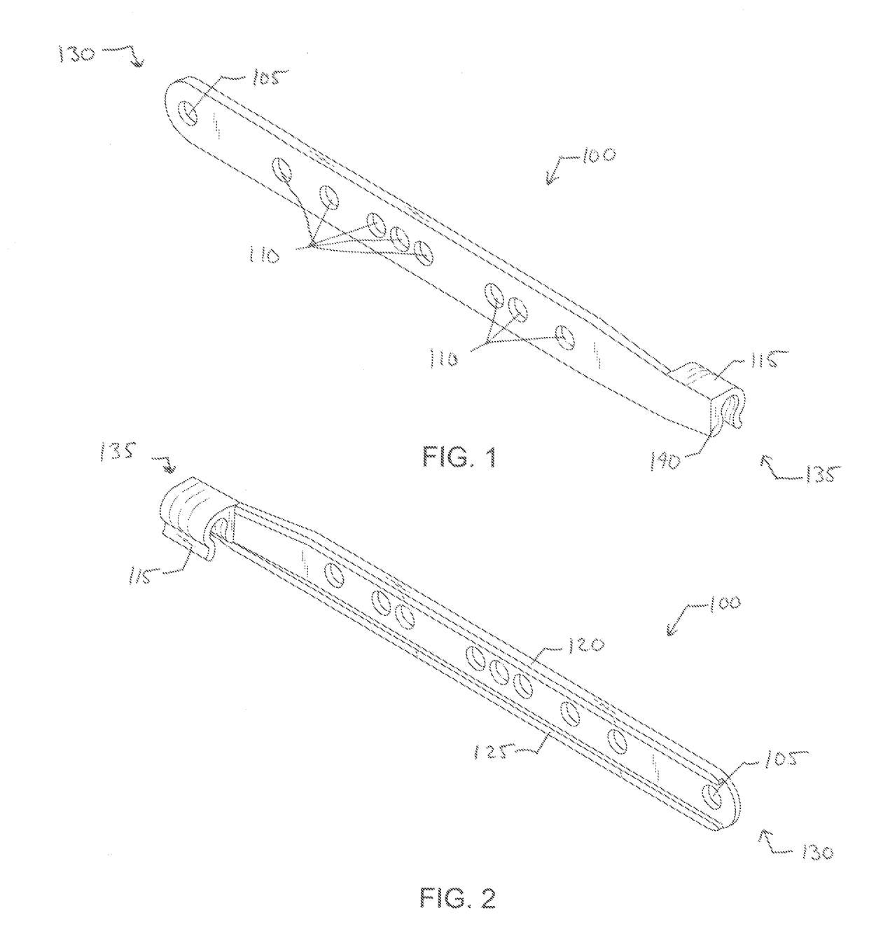

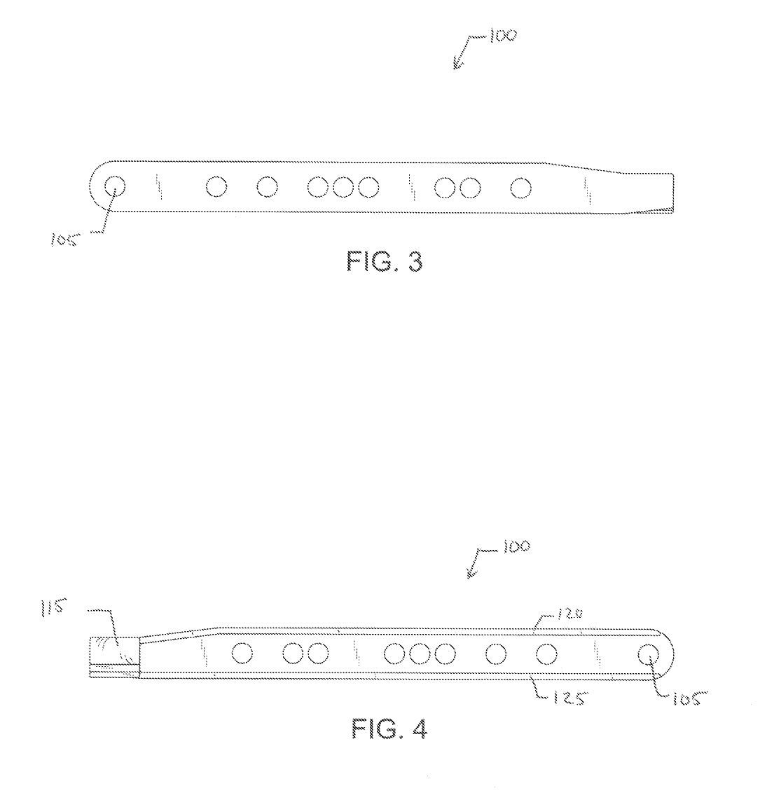

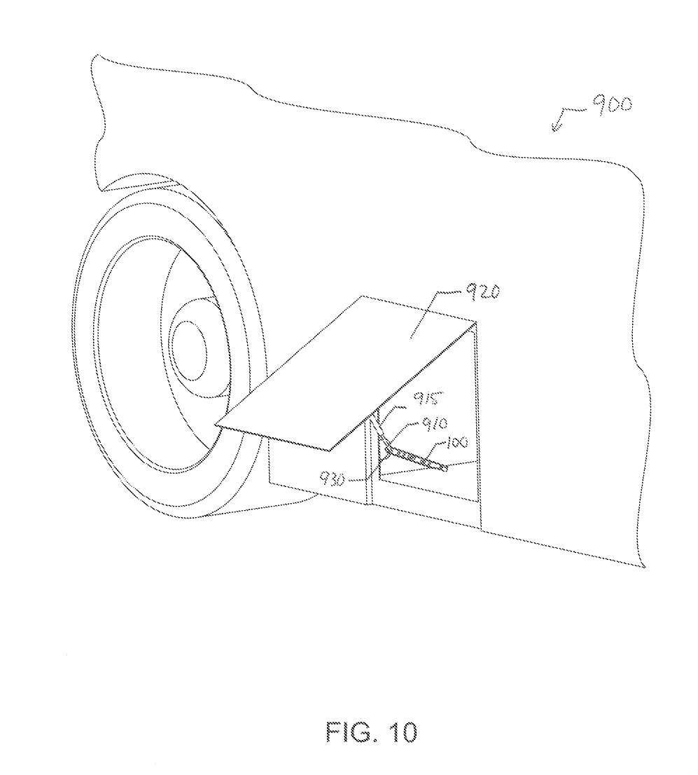

A gas strut support 100 can attach to the gas strut 905, as shown in FIG. 9. The gas strut support 100 can serve a variety of useful purposes, including maintaining the piston rod 910 of the gas strut in a partially or fully extended position. As shown in FIG. 1, one example of a gas strut support 100 can include a first end 130 and a second end 135 opposite the first end. The first end 130 of the gas strut support 100 can include a first mounting hole 105 that allows the gas strut support to be attached to a mounting point (e.g. 925, 930) on a vehicle 900. When mounted to a vehicle 900, the gas strut support 100 can rotate about the first mounting hole 105, for example, to achieve the positions shown in FIGS. 9 and 10. In FIG. 9, the gas strut support 100 is in an engaged position, where a clip 115 on the gas strut support is engaged with the piston rod 910 to support the weight of the openable structure 920 of the vehicle 900, thereby assuming the load bearing duty typically assumed by the gas strut. In FIG. 10, the gas strut support 100 is disengaged from the piston rod 910 and rotated about the first mounting hole 105 to a stored position where it does not interfere with opening or closing of the structure 920.

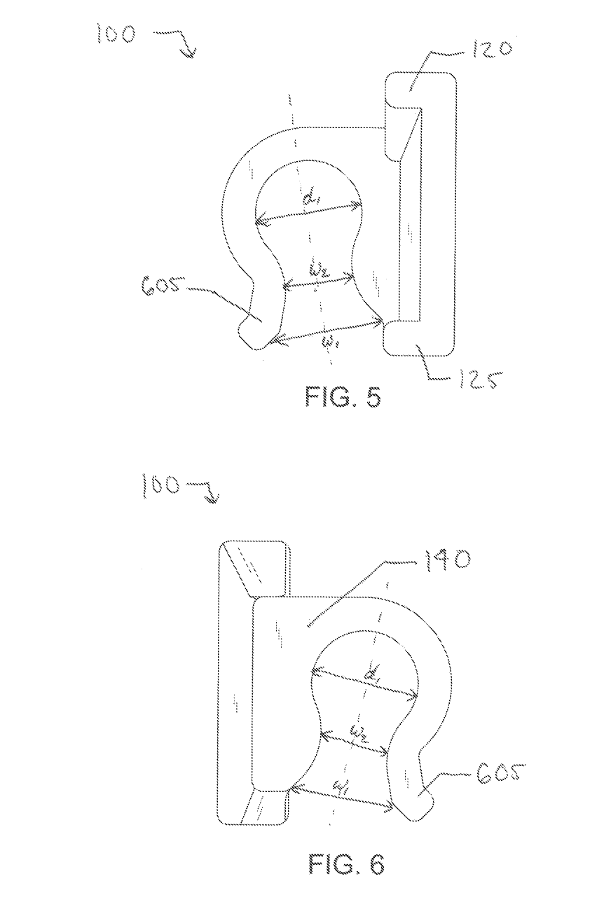

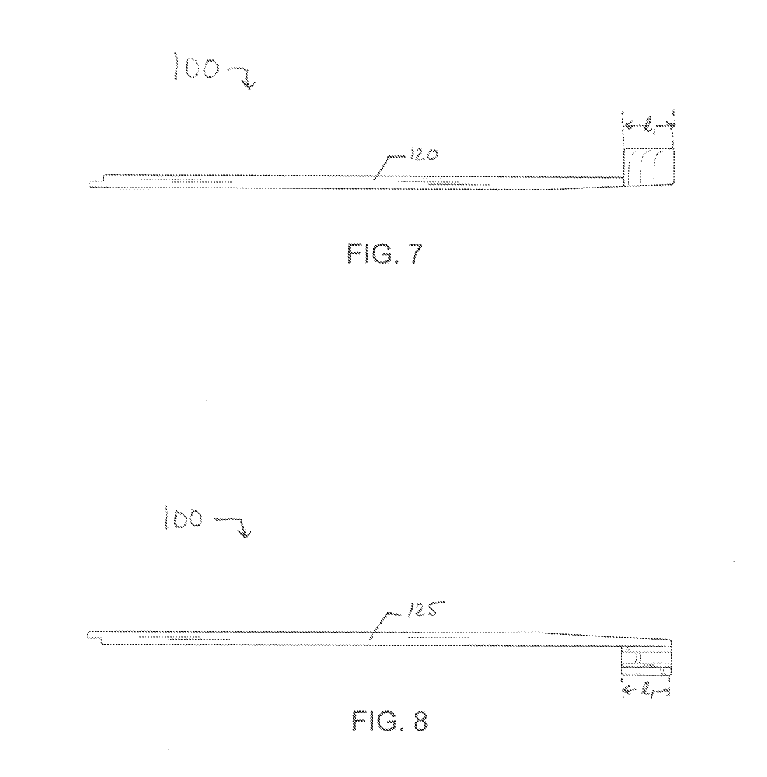

The gas strut support can include a clip 115 configured to attach to the piston rod 910. As shown in FIGS. 5 and 6, the clip 115 can have a diameter d₁ that is approximately equal to the diameter of the piston rod 910. In some instances, the diameter d₁ may be slightly less than the diameter of the piston rod 910 to ensure a snug fit of the piston rod within the clip 115. The clip 115 can have a shape that allows it to easily receive the piston rod 910 during installation. For instance, the clip 115 can include a wide opening that serves as a mouth to receive the piston rod 910. The wide opening can have a width w₁, where w₁ is greater than the diameter of the piston rod 910. The clip 115 can also include a narrow opening through which the piston rod 910 must pass during installation. The narrow opening can have a width w₂ that is less than the diameter of the piston rod 910. During installation, outward flexing of a clip arm 605 permits the width w₂ of the narrow opening to increase, thereby permitting the piston rod 910 to pass when entering an inner opening of the clip having diameter d₁. Once the piston rod 910 has passed into the inner opening, the narrow opening can return to its original width w₂, and can serve to resist the piston rod from exiting the inner opening. The clip 115 can have any suitable length, such as about 0.125 to 6.0, 0.125 to 2.0, 0.5 to 3.0, or 1.0 to 2.0 inches, where the length of the clip is measured as shown in FIGS. 7 and 8. In one example shown in FIG. 2, where the gas strut support 100 is designed to be compatible with gas struts typically found on automobiles (e.g. gas struts typically connected to toneau covers, liftgates, hoods, hatches, and trunks), the length l₁ of the clip 115 can be about 0.5-2 inches. The overall length of the gas strut support can vary depending on its intended application and can be about 0.5-5, 1-4, 1.5-4, 1.5-3, or 2-3 feet. In the example shown in FIG. 2, where the gas strut support 100 is designed to be compatible with gas struts typically found on automobiles, the overall length of the gas strut support 100 can be about 4-18, 4-12, or 4-8 inches.

In addition to the clip 115, or as an alternative to the clip, the gas strut support 100 can include a contact member that is configured to engage the second end of the cylinder proximate the sealed opening from which the piston rod extends. The contact member can be a cup, flat plate, or other suitably shaped contact member configured to engage the second end of the cylinder. The cup can be configured to receive the second end of the cylinder and can include a slot to accommodate the piston rod. This embodiment can provide an advantage of functioning without contacting the relatively delicate surfaces of the piston rod 910 and thereby reducing the likelihood of unintentionally marring or scratching the piston rod.

In one example, a gas strut support 100 that is designed to be quickly installed without any tools can include a first clip located at a first end 130 and a second clip located at a second end 135. In another example, a gas strut support 100 that is designed to be quickly installed without any tools can include a clip 115 located at a first end 130 and a contact member located at a second end 135. In yet another example, a gas strut support 100 that is designed to be quickly installed without any tools can include a contact member located at a first end 130 and a clip 115 located at a second end 135. In still another example, a gas strut support 100 that is designed to be quickly installed without any tools can include a first contact member located at a first end 130 and a second contact member located at a second end 135.

The gas strut support 100 can be made from any suitable material or combination of materials, including plastic, metal, carbon fiber, wood, resin, or any combination thereof. In one example, the gas strut support can be made of NYLON, which can provide suitable durability, flexibility, and corrosion resistance, in addition to being relatively easy and affordable to manufacture. The clip 115 or contact member can be constructed from a material, such as a polymer, that is softer than the metal of the piston rod material to avoid scratching the piston rod's surface finish. In another example, the clip 115 or contact member can be coated with a relatively soft material, such as fabric (e.g. felt) or a polymer layer, to avoid scratching the piston rod's surface finish.

To increase the stiffness of the gas strut support 100, and thereby prevent flexing or bowing of the gas strut support during use, it can be desirable to include stiffening ribs in the gas strut support. In one example shown in FIGS. 2 and 5, the gas strut support 100 can include a first stiffening rib 120 extending from a first end to a second end of the gas strut support. The first stiffening rib can be located along a top surface of the gas strut support. The gas strut support 100 can also include a second stiffening rib 125 extending from a first end to a second end of the gas strut support. The second stiffening rib 125 can be located along a bottom surface of the gas strut support.

The gas strut support 100 can include a plurality of mounting holes 110 between the first and second ends of the gas strut support, as shown in FIG. 1. The plurality of mounting holes 110 can be in addition to the first mounting hole 105. The plurality of mounting holes 110 can provide additional mounting options depending upon the application and depending on whether the user wants the gas strut support to hold the piston rod of the gas strut in a partially or fully extended position. For example, if the user wants to maintain the piston rod in a partially extended position, the user can mount the gas strut support using one of the plurality of holes 110 that is centrally located along the gas strut support 100. On the other hand, if the user wants to keep the piston rod fully extended, the user can mount the gas strut support using the first mounting hole 105 that is located near the end of the gas strut support.

The gas strut support 100 can include a support surface 140 proximate the second end 135 of the gas strut support, as shown in FIG. 1. The support surface 140 can be configured to contact a surface of the gas strut 905 when a compressive force is applied between the piston rod 910 and the cylinder 915 of the gas strut. For instance, as shown in FIG. 9, the support surface 140 can contact the second end of the cylinder of the gas strut when a compressive force is applied between the piston rod and the cylinder, such as a compressive force resulting from the weight of the structure 920.

In one example, the gas strut support 100 can attach to a gas strut 905 that lacks sufficient gas pressure to maintain the piston rod 910 in an extended position when a compressive force is applied to the gas strut. In this example, the gas strut support 100 can serve as a load-bearing member capable of withstanding the compression force exerted by a structure to which the gas strut is attached.

In another example, the gas strut support 100 can be used when performing maintenance on the gas strut 905 or other gas struts. For instance, a sport utility vehicle with a liftgate may have two gas struts extending from the liftgate to the vehicle body. Often one gas strut will fail before the second. A mechanic must then replace the failed gas strut. To do so, the mechanic must open the liftgate completely so that the first piston rod 910 is fully extended from the first cylinder 915. This ensures that no potential energy is stored in the first gas strut, which would otherwise make disconnecting the first and second end fittings of the first gas strut difficult, and could be dangerous for the mechanic. Hence, it is desirable to open the liftgate completely when removing the failed first gas strut. However, once the failed first gas strut is removed, the entire closing force of the liftgate is transferred to the functioning second gas strut. In addition to a compressive force, unsymmetrical loading can result in a moment being applied to the functioning second gas strut, which can result in bending of the second piston rod or damage to the mounting hardware. Attaching a gas strut support 100 to the functioning second gas strut can prevent damage and can also ensure that the second piston rod of the functioning second gas strut does not partially retract when the full load of the liftgate is transferred to the functioning second gas strut after the failed first gas strut has been removed. With the gas strut support 100 installed, the liftgate remains completely open, which allows the mechanic to easily install a new gas strut support with its piston rod fully extended.

In another example, a contractor may have a tonneau cover installed over a bed of a pickup truck, and a pair of gas struts may support the tonneau cover. The contractor may keep the tonneau cover in an open position during the workday to provide easy access to equipment stored in the bed of the truck. Strong winds may cause the tonneau cover to close abruptly and unwantedly, potentially damaging the tonneau cover, truck bed, or gas struts. In another example, heavy snow accumulation on an open tonneau cover may cause the tonneau cover to close unwantedly. In yet another example, when a truck is traveling on the open road with a tonneau cover in an opened position to accommodate an oversized load that protrudes from the tailgate (e.g. drywall panels, cement boards, or lumber), wind resistance may cause the tonneau cover to close abruptly and unwantedly, potentially damaging the tonneau cover, truck bed, oversized load, or gas struts. To prevent this from occurring, a gas strut support 100 can be installed to prevent the tonneau cover from closing, similar to FIG. 9. When the contractor wants to close the tonneau cover, he or she can simply disengage and stow the gas strut support, similar to the configuration shown in FIG. 10.

In yet another example, installing the gas strut support 100 can provide a low cost alternative to replacing a failed gas strut. For instance, instead of replacing a relatively costly gas strut, an individual can instead install a gas strut support 100 proximate the failed gas strut. To hold open a compartment 920 intended to be supported by a failed gas strut 905, the gas strut support 100 can engage the gas strut while the gas strut is in an opened position, as shown in FIG. 9. To close the compartment 920, the gas strut support 100 can be disengaged from the failed gas strut 905 and stowed, as shown in FIG. 10.

In one example, a gas strut support 100 can include a first end 130 and a second end 135 opposite the first end, a first mounting hole 105 proximate the first end where the first mounting hole is configured to attach to a gas strut mount. The gas strut support 100 can include a clip 115 located proximate the second end 135 of the gas strut support, and the clip can be configured to attach to a piston rod of a gas strut. The gas strut support 100 can be configured to prevent the piston rod from retracting into a cylinder of the gas strut when a compressive force is applied between the piston rod and the cylinder of the gas strut. The gas strut support 100 can include a first stiffening rib 120 extending from the first end 130 to the second end 135 of the gas strut support. The first stiffening rib can be located along a top surface of the gas strut support 100. The gas strut support 100 can include a second stiffening rib 125 extending from the first end 130 to the second end 135 of the gas strut support. The second stiffening rib 125 can be located along a bottom surface of the gas strut support 100. The gas strut support 100 can include a plurality of mounting holes 110 arranged between the first end 130 and the second end 135 of the gas strut support. The clip 115 can have an inner diameter (d₁) that is approximately equal to an outer diameter of the piston rod of the gas strut. The clip 115 can have a first width (w₁) that is greater than the outer diameter of the piston rod. The clip 115 can have a second width (w₂) that is less than the outer diameter of the piston rod. The gas strut support 100 can include a support surface 140 proximate the second end 135 of the gas strut support. The support surface 140 can be configured to contact a surface of the gas strut when the compressive force is applied between the piston rod and the cylinder of the gas strut.

In another example, a gas strut support 100 can include a first end 130 and a second end 135 opposite the first end. The first end 130 of the gas strut support 100 can be configured to attach to a first portion of a gas strut, and the second end 135 of the gas strut support is configured to attach to a second portion of the gas strut. The gas strut support 100 can be configured to prevent a piston rod of the gas strut from retracting into a cylinder of the gas strut when a compressive force is applied between the piston rod and the cylinder of the gas strut. In one instance, the first end 130 of the gas strut support 100 can include a first mounting hole 105, and the second end 135 of the gas strut support can include a clip 115 configured to attach to the piston rod of the gas strut. In another instance, the first end 130 of the gas strut support can include a first clip configured to attach to the piston rod, and the second end 135 of the gas strut support can include a second clip 115 configured to attach to the piston rod. In yet another instance, the first end 130 of the gas strut support 100 can include a clip configured to attach to the piston rod, and the second end 135 of the gas strut support can include a cup configured to engage a second end of the cylinder proximate a sealed opening from which the piston rod extends. In still another instance, the first end of the gas strut support can include a mounting hole 105, and the second end of the gas strut support can include a cup configured to engage a second end of the cylinder proximate a sealed opening from which the piston rod extends. In yet another instance, the first end 130 of the gas strut support 100 can include a cup, and the second end 135 of the gas strut support can include a cup configured to engage a second end of the cylinder proximate a sealed opening from which the piston rod extends. The gas strut support 100 can be made of any suitable material, such as plastic, metal, carbon fiber, or wood. The clip 115 can be made of any suitable material, such as NYLON, that prevents scratching or marring of the piston rod's outer surface.

A method of supporting a gas strut can include attaching a first end 130 of a gas strut support 100 to a gas strut mount and attaching a second end 135 of the gas strut support to a piston rod of the gas strut. Attaching the first end 130 of the gas strut support 100 to the gas strut mount can include inserting a fastener though a first mounting hole 105 in the first end of the gas strut support. Attaching the second end 135 of the gas strut support to the piston rod of the gas strut can include attaching a clip 115 at the second end of the gas strut support to the piston rod of the gas strut. In one example, a finger can be used to apply force to the clip 115 to encourage the clip to engage the piston rod.

The concepts described herein and defined by the enumerated claims may be better understood by referring to the description, which should be read in conjunction with the accompanying figures. The descriptions of certain embodiments are set out to enable one to build and use implementations of the invention, and are not intended to limit the enumerated claims, but rather to serve as particular examples thereof. Those skilled in the art should appreciate that they may readily use the conception and specific embodiments disclosed as a basis for modifying or designing other methods and systems for carrying out the same purposes. Those skilled in the art should also realize that such equivalent assemblies do not depart from the spirit and scope of the invention in its broadest form.

What is claimed is:

1. A gas strut support comprising:
a first end and a second end opposite the first end;
a first mounting hole proximate the first end, wherein the first mounting hole is configured to attach to a gas strut mount; and
a clip located proximate the second end of the gas strut support, wherein the clip is configured to attach to a piston rod of a gas strut, and wherein the gas strut support is configured to prevent the piston rod from retracting into a cylinder of the gas strut when a compressive force is applied between the piston rod and the cylinder of the gas strut.

2. The gas strut support of claim 1, further comprising a first stiffening rib extending from the first end to the second end of the gas strut support, wherein the first stiffening rib is located along a top surface of the gas strut support.

3. The gas strut support of claim 1, further comprising a second stiffening rib extending from the first end to the second end of the gas strut support, wherein the second stiffening rib is located along a bottom surface of the gas strut support.

4. The gas strut support of claim 1, further comprising a plurality of mounting holes arranged between the first end and the second end of the gas strut support.

5. The gas strut support of claim 1, wherein the clip comprises:
an inner diameter that is approximately equal to an outer diameter of the piston rod of the gas strut;
a first width that is greater than the outer diameter of the piston rod; and
a second width that is less than the outer diameter of the piston rod.

6. The gas strut support of claim 5, wherein the second width of the clip is configured to expand to permit the piston rod to pass into the inner diameter of the clip during engagement of the clip to the piston rod.

7. The gas strut support of claim 1, further comprising a support surface proximate the second end of the gas strut support, wherein the support surface is configured to contact a surface of the gas strut when the compressive force is applied between the piston rod and the cylinder of the gas strut.

8. The gas strut support of claim 1, wherein the overall length of the gas strut support is about 4-12 inches.

9. The gas strut support of claim 1, wherein the length of the clip is about 0.125-2 inches.

10. A gas strut support comprising:
a first end; and
a second end opposite the first end,
wherein the first end of the gas strut support is configured to attach to a first portion of a gas strut, wherein the second end of the gas strut support is configured to attach to a second portion of the gas strut, and wherein the gas strut support is configured to prevent a piston rod of the gas strut from retracting into a cylinder of the gas strut when a compressive force is applied between the piston rod and the cylinder of the gas strut.

11. The gas strut support of claim 10, wherein the first end of the gas strut support comprises a first mounting hole, and wherein the second end of the gas strut support comprises a clip configured to attach to the piston rod of the gas strut.

12. The gas strut support of claim 10, wherein the first end of the gas strut support comprises a first clip configured to attach to the piston rod of the gas strut, and wherein the second end of the gas strut support comprises a second clip configured to attach to the piston rod of the gas strut.

13. The gas strut support of claim 10, wherein the first end of the gas strut support comprises a clip configured to attach to the piston rod of the gas strut, and wherein the second end of the gas strut support comprises a cup configured to engage a second end of the cylinder of the gas strut proximate a sealed opening from which the piston rod extends.

14. The gas strut support of claim 10, wherein the first end of the gas strut support comprises a mounting hole, and wherein the second end of the gas strut support comprises a cup configured to engage a second end of the cylinder of the gas strut proximate a sealed opening from which the piston rod extends.

15. The gas strut support of claim 10, wherein the first end of the gas strut support comprises a first cup configured to engage a second end of the piston rod of the gas strut, and wherein the second end of the gas strut support comprises a second cup configured to engage a second end of the cylinder of the gas strut proximate a sealed opening from which the piston rod extends.

16. The gas strut support of claim 10, wherein the first end of the gas strut support comprises a first contact member configured to engage a second end of the piston rod of the gas strut, and wherein the second end of the gas strut support comprises a second contact member to engage a second end of the cylinder of the gas strut proximate a sealed opening from which the piston rod extends.

17. The gas strut support of claim 10, wherein the gas strut support comprises plastic, carbon fiber, or wood.

18. A method of supporting a gas strut, the method comprising:
attaching a first end of a gas strut support to a gas strut mount; and
attaching a second end of the gas strut support to a piston rod of the gas strut, wherein the gas strut support is configured to prevent a piston rod of the gas strut from retracting into a cylinder of the gas strut when a compressive force is applied between the piston rod and the cylinder of the gas strut.

19. The method of claim 18, wherein attaching the first end of the gas strut support to the gas strut mount comprises inserting a fastener though a first mounting hole in the first end of the gas strut support.

20. The method of claim 18, wherein attaching the second end of the gas strut support to the piston rod of the gas strut comprises attaching a clip at the second end of the gas strut support to the piston rod of the gas strut.
